(19) United States
(12) Patent Application Publication
(10) Pub. No.: US 2014/0104161 A1
(43) Pub. Date: Apr. 17, 2014

(54) GESTURE CONTROL DEVICE AND METHOD FOR SETTING AND CANCELLING GESTURE OPERATING REGION IN GESTURE CONTROL DEVICE

(71) Applicant: WISTRON CORPORATION, New Taipei City (TW)

(72) Inventors: Chih-Pin Liao, New Taipei City (TW); Pin-Hong Liou, New Taipei City (TW); Che-You Kuo, New Taipei City (TW)

(73) Assignee: Wistron Corporation, New Taipei City (TW)

(21) Appl. No.: 13/888,389

(22) Filed: May 7, 2013

(30) Foreign Application Priority Data
Oct. 16, 2012 (TW) 101138066

(51) Int. Cl. G06F 3/01

(52) U.S. Cl. CPC G06F 3/017
USPC 345/156

(57) ABSTRACT

A method for setting and cancelling a gesture operating region in a gesture control device includes steps of capturing at least one image; detecting whether there is a palm in the at least one image; if there is a palm in the at least one image, detecting whether there is a face in the at least one image; if there is a face in the at least one image, setting the gesture operating region according to the palm and the face; and cancelling the gesture operating region when the palm is at rest over a first time period or the palm disappears from the gesture operating region over a second time period.

### BACKGROUND OF THE INVENTION

1. Field of the Invention

The invention relates to a gesture control device and, more particularly, to a method for setting and cancelling a gesture operating region in a gesture control device.

2. Description of the Prior Art

So far a user usually operates an electronic device by an input device, such as keyboard, mouse, touch panel, remote controller, and so on. However, since the user has to hold or touch those input devices including keyboard, mouse, touch panel, remote controller, and so on for operation, it is inconvenient for the user. As motion control gets more and more popular, the present operation behavior of user may change in the future, wherein gesture control may be adapted for various applications. In general, gesture control is implemented by installing an image capturing module on an upper middle portion of a display device (or TV) so as to capture a gesture image of a user facing the display device. Afterward, the gesture image is analyzed by software or hardware so as to operate an operating object in the display screen. At present, a conventional gesture control device provides a gesture operating region, which has fixed size and location, in the display screen of the display device using the gesture image captured by the image capturing module such that the user can perform a gesture within the fixed gesture operating region to execute related function. However, the build, standing pose including a location where the user stands and an angle which the user faces the image capturing module, dominant hand and so on of different users are not exactly the same. Therefore, if a gesture performed by a user is out of the gesture operating region or the user is replaced by another user with different build, standing pose, dominant hand and so on, the gesture control device may not be controlled normally to execute related function. In other words, the fixed gesture operating region is inconvenient for different users in operation.

### SUMMARY OF THE INVENTION

The invention provides a gesture control device and a method for setting and cancelling a gesture operating region in the gesture control device so as to solve the aforesaid problems.

According to an embodiment of the invention, a method for setting and cancelling a gesture operating region in a gesture control device comprises steps of capturing at least one image; detecting whether there is a palm in the at least one image; if there is a palm in the at least one image, detecting whether there is a face in the at least one image; if there is a face in the at least one image, setting the gesture operating region according to the palm and the face; and cancelling the gesture operating region when the palm is at rest over a first time period or the palm disappears from the gesture operating region over a second time period.

According to another embodiment of the invention, a gesture control device comprises an image capturing unit and a processing unit, wherein the processing unit is electrically connected to the image capturing unit. The image capturing unit is used for capturing at least one image. The processing unit detects whether there is a palm in the at least one image. If there is a palm in the at least one image, the processing unit detects whether there is a face in the at least one image. If there is a face in the at least one image, the processing unit sets a gesture operating region according to the palm and the face. The processing unit cancels the gesture operating region when the processing unit detects that the palm is at rest over a first time period or the palm disappears from the gesture operating region over a second time period.

As mentioned in the above, the invention detects whether there is a palm first after capturing an image so as to obtain a location of a user and then detects whether there is a face so as to set a gesture operating region corresponding to the user according to the palm and the face. When the palm is at rest over a first time period (e.g. five seconds) or the palm disappears from the gesture operating region over a second time period (e.g. three seconds), the gesture operating region will be cancelled accordingly. In other words, when the user changes his/her standing pose or changes his/her dominant hand to non-dominant hand, the user can cancel the original gesture operating region and reset a new gesture operating region by the aforesaid operation manner. In a similar way, when the current user is replaced by another user, the new user can also cancel the original gesture operating region and reset a new gesture operating region by the aforesaid operation manner. Accordingly, the invention can set a gesture operating region suitable for a specific user according to the build, standing pose, dominant hand and so on of the user. Furthermore, the invention allows the user to cancel the original gesture operating region and reset a new gesture operating region according to his/her using requirements.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a gesture control device according to an embodiment of the invention.

FIG. 2 is a functional block diagram illustrating the gesture control device shown in FIG. 1.

FIG. 3 is a flowchart illustrating a method for setting and cancelling a gesture operating region in the gesture control device according to an embodiment of the invention.

FIG. 4 is a schematic diagram illustrating an image captured by the image capturing unit shown in FIG. 1, wherein the image can be displayed (or not displayed) in the display screen of the display unit.

FIG. 5 is schematic diagram illustrating a user shaking a palm.

FIG. 6 is a schematic diagram illustrating the processing unit detecting that there are a palm and a face of the user in the image.

FIG. 7 is a schematic diagram illustrating the processing unit setting a gesture operating region according to the palm and the face.

FIG. 8 is a schematic diagram illustrating the processing unit setting another gesture operating region according to the palm and the face.

FIG. 9 is a schematic diagram illustrating the user moving the palm out of the gesture operating region.

FIG. 10 is a schematic diagram illustrating the user changing the palm into a first in the gesture operating region.

### DETAILED DESCRIPTION

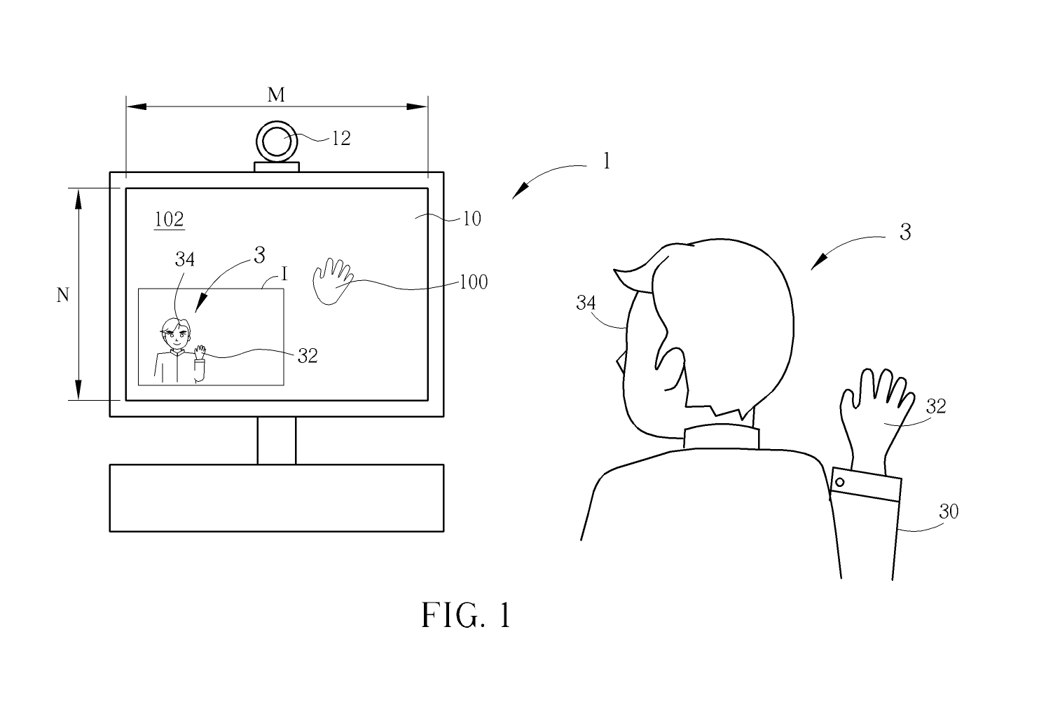

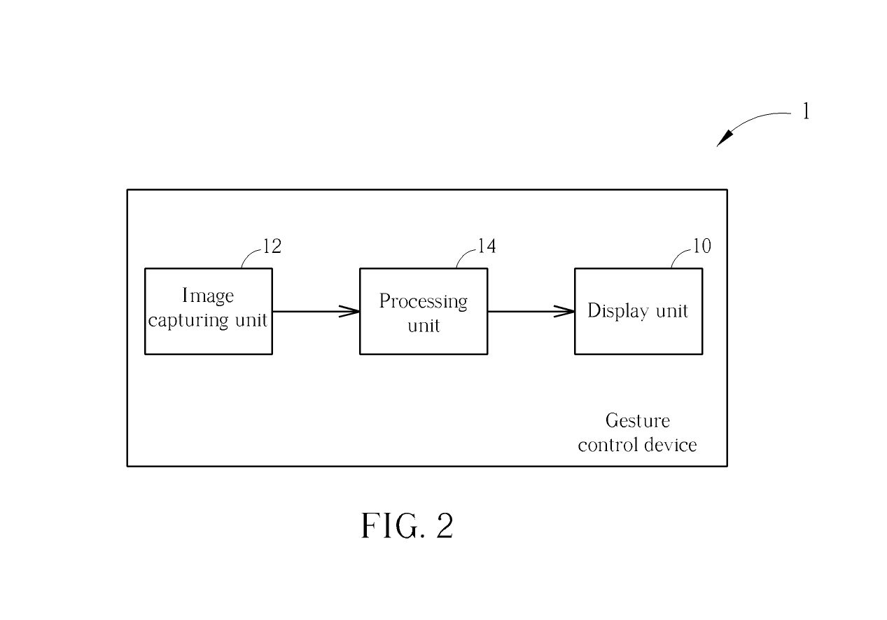

Referring to FIGS. 1 and 2, FIG. 1 is a schematic diagram illustrating a gesture control device 1 according to an embodiment of the invention, and FIG. 2 is a functional block diagram illustrating the gesture control device 1 shown in FIG. 1. The gesture control device 1 of the invention may be any electronic devices with data processing function, such as All-in-One PC, Smart TV, Notebook PC, etc. As shown in FIGS. 1 and 2, the gesture control device 1 comprises a display unit 10, an image capturing unit 12 and a processing unit 14, wherein the display unit 10 and the image capturing unit 12 are electrically connected to the processing unit 14. A user 3 can use his/her hand 30 to perform a gesture in front of the image capturing unit 12 and then the processing unit 14 of the gesture control device 1 identifies image(s) captured by the image capturing unit 12, so as to control a gesture corresponding object 100 (e.g. cursor) or other user interfaces to execute corresponding function within a display screen 102 displayed by the display unit 10.

In practical applications, the display unit 10 may be a liquid crystal display device, other display devices or a projection screen, the image capturing unit 12 may be, but not limited to, a charge-coupled device (CCD) sensor or a complementary metal-oxide semiconductor (CMOS) sensor, and the processing unit 14 may be a processor or a controller with data calculating/processing function. In general, the gesture control device 1 may be further equipped with some necessary hardware or software components for specific purposes, such as a memory, a storage device, a power supply, an operating system, etc., and it depends on practical applications.

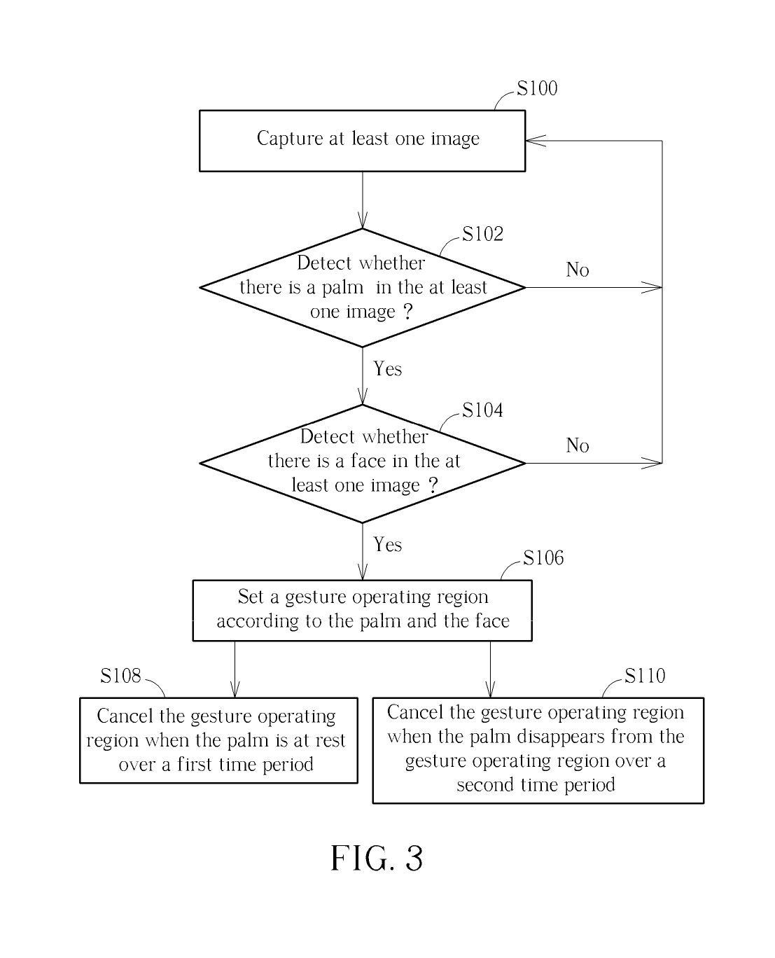

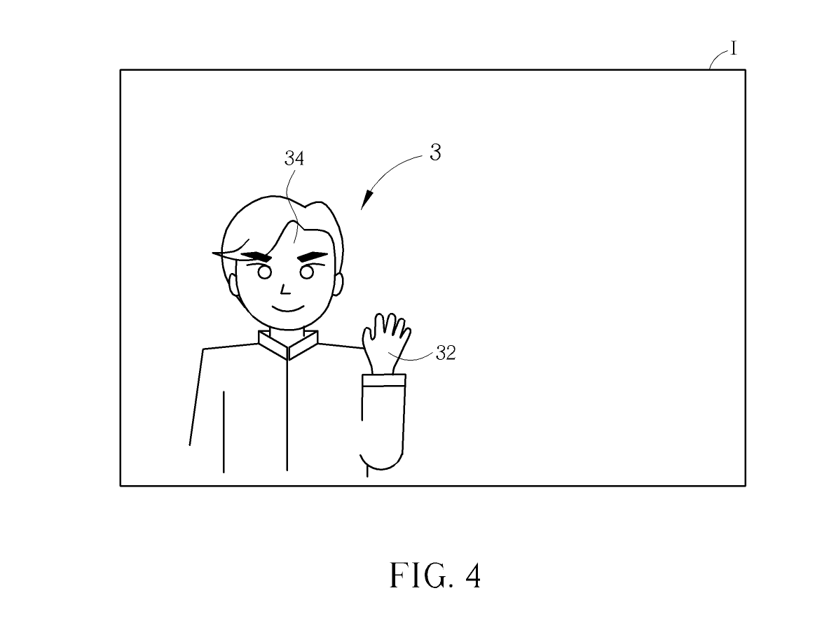

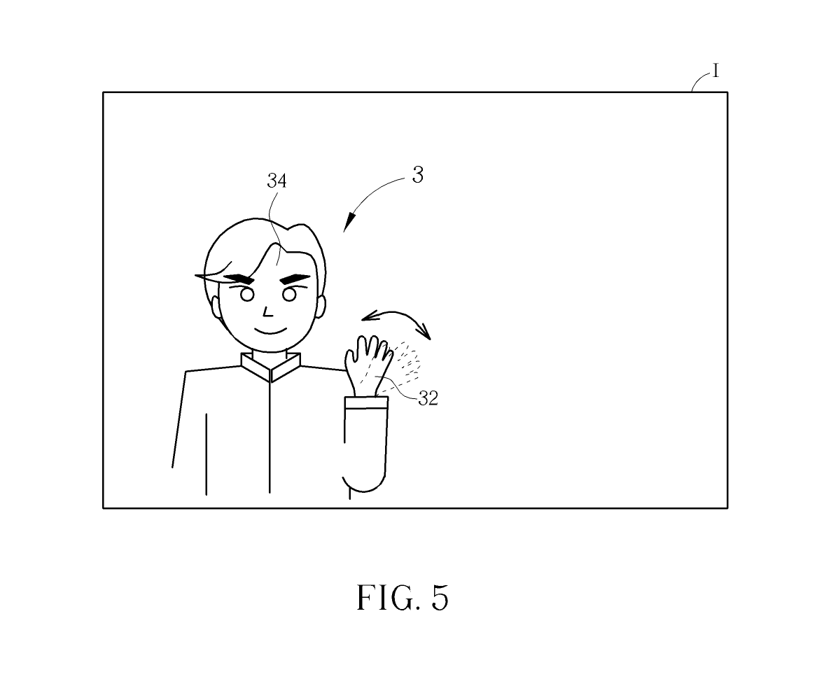

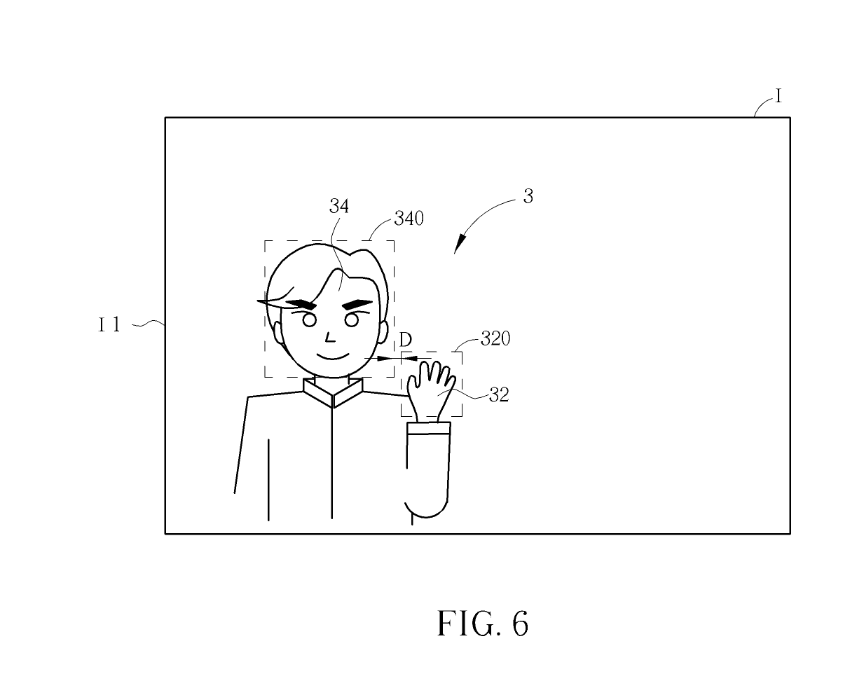

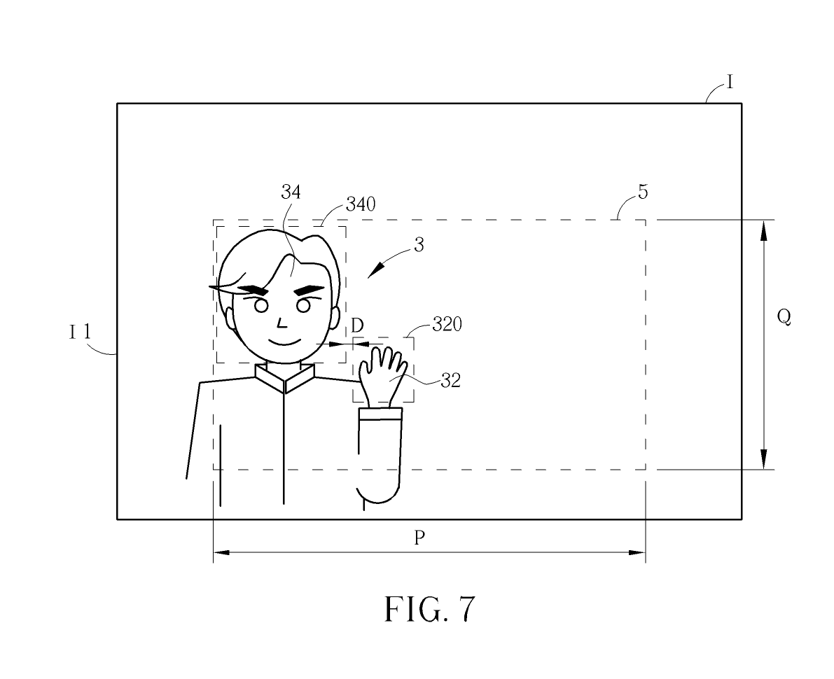

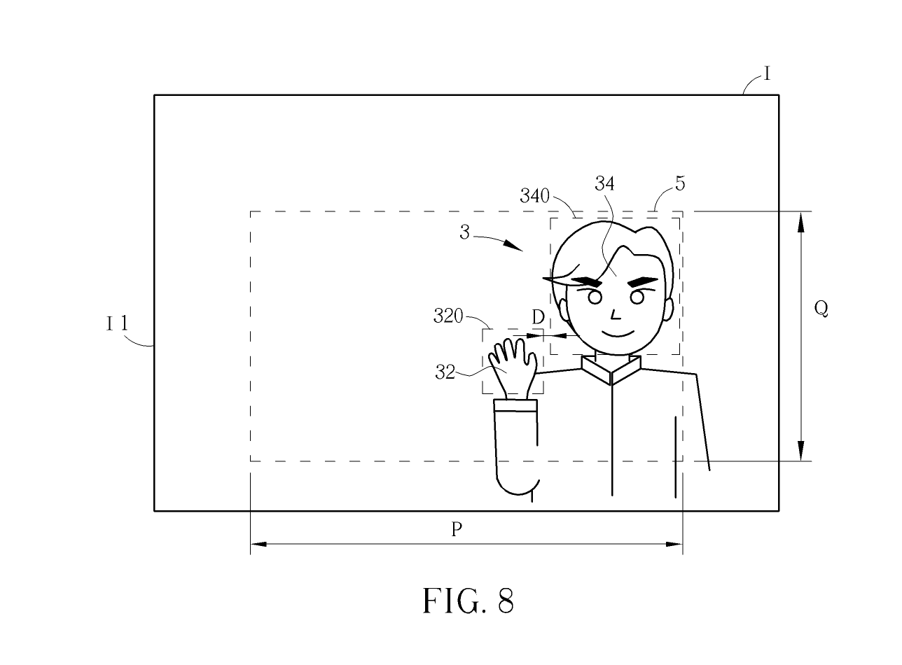

Referring to FIGS. 3 to 8, FIG. 3 is a flowchart illustrating a method for setting and cancelling a gesture operating region in the gesture control device 1 according to an embodiment of the invention; FIG. 4 is a schematic diagram illustrating an image I captured by the image capturing unit 12 shown in FIG. 1, wherein the image I can be displayed (or not displayed) in the display screen 102 of the display unit 10; FIG. 5 is schematic diagram illustrating a user 3 shaking a palm 32; FIG. 6 is a schematic diagram illustrating the processing unit 14 detecting that there are a palm 32 and a face 34 of the user 3 in the image I; FIG. 7 is a schematic diagram illustrating the processing unit 14 setting a gesture operating region 5 according to the palm 32 and the face 34; and FIG. 8 is a schematic diagram illustrating the processing unit 14 setting another gesture operating region 5 according to the palm 32 and the face 34.

When the user 3 is located in front of the image capturing unit 12 and raises the hand 30 (as shown in FIG. 1), the image capturing unit 12 captures at least one image I (as shown in FIG. 4) in step S100 of FIG. 3. It should be noted that the aforesaid hand 30 may be right hand or left hand of the user 3 and this embodiment utilizes right hand of the user 3 to depict the features of the invention. Furthermore, the image I can be displayed or not displayed in the display screen 102 of the display unit 10 and it depends on practical applications. Afterward, the processing unit 14 detects whether there is a palm 32 of the user 3 in the at least one image I in step S102 of FIG. 3. In this embodiment, the user 3 can shake the palm 32 (as shown in FIG. 5) such that the processing unit 14 can detect the palm 32 rapidly from a series of images captured by the image capturing unit 12 so as to enhance detection rate. For example, the processing unit 14 can detect whether there is a moving object (e.g. the shaken palm 32) in the at least one image I. If there is a moving object in the at least one image I, the processing unit 14 determines whether the moving object is the palm 32 of the user 3 according to image characteristics stored in a database (not shown).

If there is a palm 32 of the user 3 in the at least one image I, the processing unit 14 detects whether there is a face 34 of the user 3 in the at least one image I in step S104 of FIG. 3. If the palm 32 of the user 3 is not in the at least one image I, go back to the step S100 of FIG. 3. If there is a face 34 of the user 3 in the at least one image I, the processing unit 14 sets a gesture operating region 5 (as shown in FIGS. 7 and 8) according to the palm 32 and the face 34 in step S106 of FIG. 3. If the face 34 of the user 3 is not in the at least one image I, go back to the step S100 of FIG. 3.

In this embodiment, when the processing unit 14 detects that the palm 32 of the user 3 is in the at least one image I, the processing unit 14 can define a palm region 320 for the palm 32; and when the processing unit 14 detects that the face 34 of the user 3 is in the at least one image I, the processing unit 14 can define a face region 340 for the face 34, as shown in FIG. 6. Furthermore, the processing unit 14 can detects the face 34 within an area between the palm 32 and a boundary I1 of the at least one image I. In other words, the processing unit 14 need not detect the face 34 within the whole image I so as to enhance detection rate.

In this embodiment, a scale of the gesture operating region is corresponding to a scale of the display screen 102. As shown in FIGS. 1 and 7, since the size of the display screen 102 is M*N and the size of the gesture operating region 5 is P*Q, P/Q is equal to M/N. In other words, the user 3 can use the palm 32 to perform any gestures in the gesture operating region 5 so as to execute related functions in the display screen 102, such as moving the gesture corresponding object 100, starting a program indicated by the gesture corresponding object 100, and so on.

The processing unit 14 can determine a size of the gesture operating region 5 according to a maximum extendable length of the palm 32 (i.e. the length of the arm) and a size of the face 34. For example, the gesture control device 1 may store a look-up table, as the table 1 shown in the following. As shown in the table 1, when the maximum extendable length of the palm 32 is between L₀ and L₁ and the size of the face 34 is between F₀ and F₁, the size of the gesture operating region 5 is equal to X₁.

TABLE 1

| Maximum extendable | | Size of gesture |
|---|---|---|
| length of palm 32 | Size of face 34 | operating region 5 |
| L₀~L₁ | F₀~F₁ | X₁ |
| L₁~L₂ | F₁~F₂ | X₂ |
| L₂~L₃ | F₂~F₃ | X₃ |
| . . . | . . . | . . . |
| Lₙ₋₁~Lₙ | Fₙ₋₁~Fₙ | Xₙ |

Furthermore, the processing unit 14 may also determine a size of the gesture operating region 5 according to a distance between the palm 32 and the face 34. As shown in FIG. 6, the distance between the palm 32 and the face 34 may be defined by a distance D between the palm region 320 and the face region 340. After calculating the distance D, the processing unit 14 can magnify the distance D by a predetermined value to be the size of the gesture operating region 5. For example, the distance D may be magnified by ten to be a length of the gesture operating region 5 and the distance D may be magnified by five to be a width of the gesture operating region 5. The predetermined value for magnifying the distance D can be determined according to practical applications and is not limited by the aforesaid embodiment.

After calculating the size of the gesture operating region 5, the processing unit 14 can determine a location of the gesture operating region 5 according to the face 34 and the palm 32. For example, when the palm 32 is a right palm, the processing unit 14 can locate the face 34 at an upper left corner of the gesture operating region 5, as shown in FIG. 7. On the other hand, when the palm 32 is a left palm, the processing unit 14 can locate the face 34 at an upper right corner of the gesture operating region 5, as shown in FIG. 8.

When the processing unit 14 detects that the palm 32 is at rest over a first time period (e.g. five seconds), the processing unit 14 will cancel the gesture operating region 5 in step S108 of FIG. 3. Furthermore, when the processing unit 14 detects that the palm 32 disappears from the gesture operating region 5 over a second time period (e.g. three seconds), the processing unit 14 will also cancel the gesture operating region 5 in step S110 of FIG. 3. It should be noted that the first time period may be the same as or different from the second time period according to practical applications.

In other words, when the user 3 changes his/her standing pose or changes his/her dominant hand (e.g. right hand) to non-dominant hand (e.g. left hand), the user 3 can cancel the original gesture operating region 5 by the aforesaid step S108 or S110 and reset a new gesture operating region 5 by the aforesaid steps S100-S106. In a similar way, when the current user 3 is replaced by another user, the new user can also cancel the original gesture operating region 5 by the aforesaid step S108 or S110 and reset a new gesture operating region 5 by the aforesaid steps S100-S106.

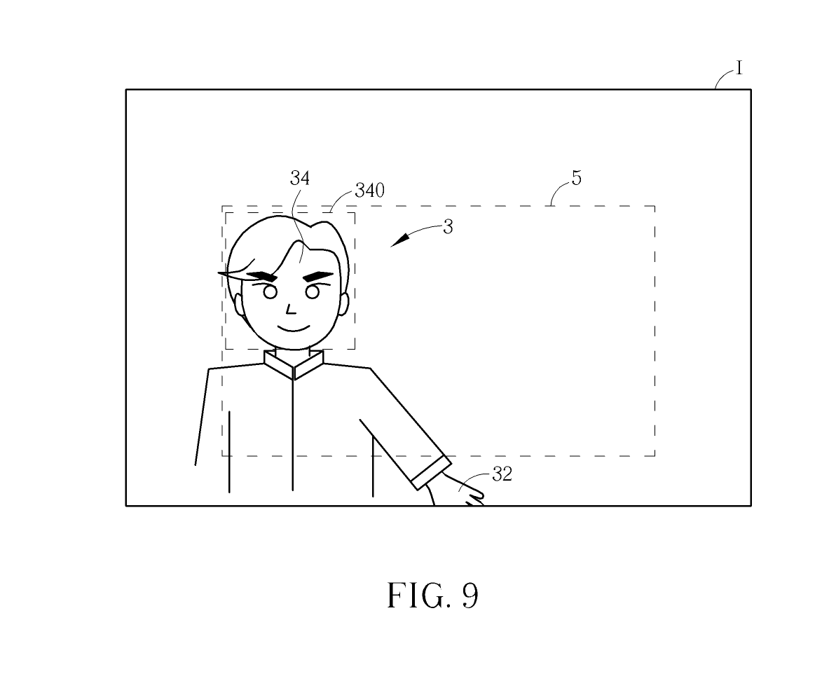

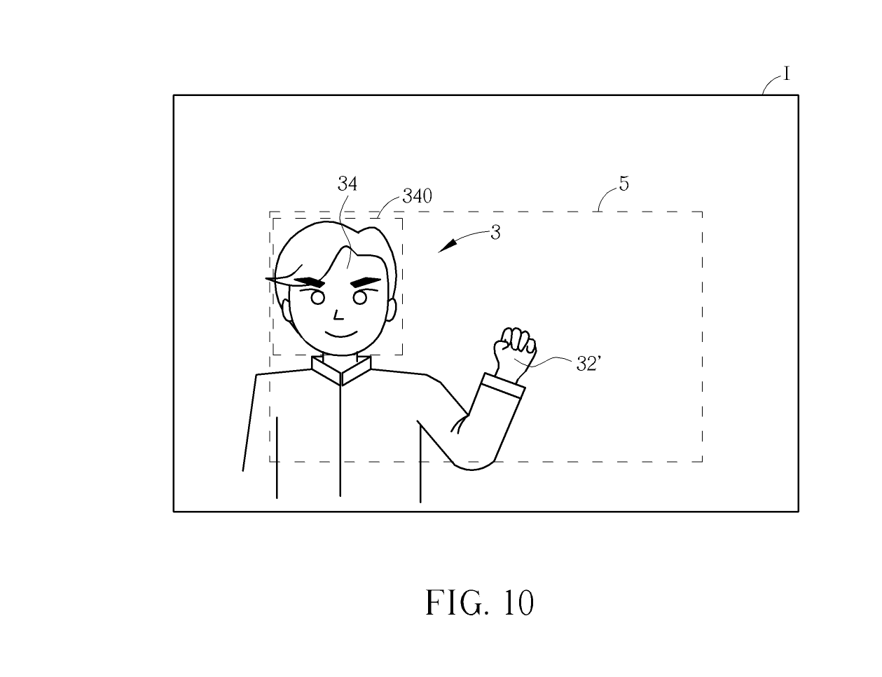

Referring to FIGS. 9 and 10, FIG. 9 is a schematic diagram illustrating the user 3 moving the palm 32 out of the gesture operating region 5 and FIG. 10 is a schematic diagram illustrating the user 3 changing the palm 32 into a first 32′ in the gesture operating region 5. As shown in FIG. 9, when the user 3 moves the palm 32 out of the gesture operating region 5 over the second time period, the processing unit 14 will determine that the palm 32 disappears from the gesture operating region 5 and then cancel the gesture operating region 5. As shown in FIG. 10, when the user 3 changes the palm 32 into a first 32′ in the gesture operating region 5 over the second time period, the processing unit 14 will also determine that the palm 32 disappears from the gesture operating region 5 and then cancel the gesture operating region 5.

In other words, in this embodiment, the user 3 can cancel the gesture operating region 5 by keeping the palm 32 at rest over the first time period, moving the palm 32 out of the gesture operating region 5 over the second time period, or changing the palm 32 into the first 32′ in the gesture operating region 5 over the second time period.

Furthermore, the control logic of the method for setting and cancelling the gesture operating region in the gesture control device 1 shown in FIG. 3 can be implemented by software. Needless to say, each part or function of the control logic may be implemented by software, hardware or the combination thereof.

As mentioned in the above, the invention detects whether there is a palm first after capturing an image so as to obtain a location of a user and then detects whether there is a face so as to set a gesture operating region corresponding to the user according to the palm and the face. When the palm is at rest over a first time period (e.g. five seconds) or the palm disappears from the gesture operating region over a second time period (e.g. three seconds), the gesture operating region will be cancelled accordingly. In other words, when the user changes his/her standing pose or changes his/her dominant hand to non-dominant hand, the user can cancel the original gesture operating region and reset a new gesture operating region by the aforesaid operation manner. In a similar way, when the current user is replaced by another user, the new user can also cancel the original gesture operating region and reset a new gesture operating region by the aforesaid operation manner. Accordingly, the invention can set a gesture operating region suitable for a specific user according to the build, standing pose, dominant hand and so on of the user. Furthermore, the invention allows the user to cancel the original gesture operating region and reset a new gesture operating region according to his/her using requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for setting and cancelling a gesture operating region in a gesture control device comprising:
capturing at least one image;
detecting whether there is a palm in the at least one image;
if there is a palm in the at least one image, detecting whether there is a face in the at least one image;
if there is a face in the at least one image, setting the gesture operating region according to the palm and the face; and
cancelling the gesture operating region when the palm is at rest over a first time period or the palm disappears from the gesture operating region over a second time period.

2. The method of claim 1, wherein detecting whether there is a palm in the at least one image comprises:
detecting whether there is a moving object in the at least one image; and
if there is a moving object in the at least one image, determining whether the moving object is the palm.

3. The method of claim 1, wherein detecting whether there is a face in the at least one image comprises:
detecting the face within an area between the palm and a boundary of the at least one image.

4. The method of claim 1, wherein setting the gesture operating region according to the palm and the face comprises:
locating the face at an upper left corner of the gesture operating region when the palm is a right palm; and
locating the face at an upper right corner of the gesture operating region when the palm is a left palm.

5. The method of claim 1, wherein setting the gesture operating region according to the palm and the face comprises:
determining a size of the gesture operating region according to a maximum extendable length of the palm and a size of the face.

6. The method of claim 1, wherein setting the gesture operating region according to the palm and the face comprises:
determining a size of the gesture operating region according to a distance between the palm and the face.

7. The method of claim 1, wherein cancelling the gesture operating region when the palm disappears from the gesture operating region over a second time period comprises:
determining that the palm disappears from the gesture operating region when the palm changes into a first in the gesture operating region over the second time period.

8. The method of claim 1, wherein a scale of the gesture operating region is corresponding to a scale of a display screen.

9. A gesture control device comprising:
an image capturing unit for capturing at least one image; and
a processing unit electrically connected to the image capturing unit, the processing unit detecting whether there is a palm in the at least one image; if there is a palm in the at least one image, the processing unit detecting whether there is a face in the at least one image; if there is a face in the at least one image, the processing unit setting a gesture operating region according to the palm and the face; and the processing unit cancelling the gesture operating region when the processing unit detects that the palm is at rest over a first time period or the palm disappears from the gesture operating region over a second time period.

10. The gesture control device of claim 9, wherein the processing unit detects whether there is a moving object in the at least one image; and if there is a moving object in the at least one image, the processing unit determines whether the moving object is the palm.

11. The gesture control device of claim 9, wherein the processing unit detects the face within an area between the palm and a boundary of the at least one image.

12. The gesture control device of claim 9, wherein the processing unit locates the face at an upper left corner of the gesture operating region when the palm is a right palm; and the processing unit locates the face at an upper right corner of the gesture operating region when the palm is a left palm.

13. The gesture control device of claim 9, wherein the processing unit determines a size of the gesture operating region according to a maximum extendable length of the palm and a size of the face.

14. The gesture control device of claim 9, wherein the processing unit determines a size of the gesture operating region according to a distance between the palm and the face.

15. The gesture control device of claim 9, wherein the processing unit determines that the palm disappears from the gesture operating region when the palm changes into a first in the gesture operating region over the second time period.

16. The gesture control device of claim 9, further comprising a display unit electrically connected to the processing unit, the display unit being used for displaying a display screen, and a scale of the gesture operating region being corresponding to a scale of the display screen.
